(19) United States
(12) Patent Application Publication
(10) Pub. No.: US 2026/0118276 A1
(43) Pub. Date: Apr. 30, 2026

(54) SUBSTRATE MODIFICATION REGION MEASUREMENT APPARATUS AND METHOD

(71) Applicants: KUN-HSIEN CHENG, Taoyuan City (TW); SHYAWEI OPTRONICS CORPORATION CO., LTD., Taoyuan City (TW)

(72) Inventor: KUN-HSIEN CHENG, Taoyuan City (TW)

(21) Appl. No.: 19/003,580

(22) Filed: Dec. 27, 2024

Related U.S. Application Data
(60) Provisional application No. 63/682,046, filed on Aug. 12, 2024.

(51) Int. Cl. G01N 21/88; G01N 21/95

(52) U.S. Cl. CPC G01N 21/8806; G01N 21/9501

(57) ABSTRACT

A substrate modification region measurement apparatus has a first image capturing device, a second image capturing device, a third image capturing device and a microcontroller unit. The first image capturing device orthogonally faces a first surface of a substrate and shoots the substrate to obtain a first image. The second image capturing device orthogonally faces a second surface of the substrate and shoots the substrate to obtain a second image, wherein the first surface of the substrate is opposite to the second surface of the substrate. The third image capturing device obliquely faces the first surface or second surface of the substrate and shoots the substrate to obtain a third image. The microcontroller unit obtains modification region measuring information of at least one modification region according to the first image, the second image and the third image.

### CROSS REFERENCE

The present disclosure claims benefit of a U.S. patent provisional application 63/682,046, which is filed on Aug. 12, 2024.

### BACKGROUND

### Technical Field

The present disclosure is related to a measurement apparatus and method for a substrate, and in particularly to, substrate modification region measurement apparatus and method, each of which is used to measure a substrate modification region.

### Related Art

A through glass via (TGV) substrate is a glass substrate with a plurality of vias, and it acts as an interposer when packaging three-dimensional or 2.5-dimensional chips, especially for integrated circuits that operate at high frequency and high speed. The TGV substrate has a higher dielectric coefficient and better anti-interference ability. Thus, it is an inevitable trend to use the TGV substrate as an interposer when packaging three-dimensional or 2.5-dimensional chips.

To obtain the TGV substrate, the first step is to modify characteristics of the glass, such that multiple modification regions are formed at specifical positions of the glass substrate. Then, the glass substrate with the multiple modification regions is soaked in an etching liquid tank to etch the modification regions and form glass vias in the modification regions. Currently, a common modification method is laser modification. The laser modification uses a laser light beam to illuminate the specific position of the glass substrate to form the modification region at the specific position of the glass substrate. At present, the measurement apparatus mainly measures the formed glass vias, but does not measure the modification region of the glass substrate after modification and before etching.

### SUMMARY

One of objectives of the present disclosure is to provide a substrate modification region measurement apparatus and method. If the modification region of the substrate is not successfully modified or has at least one defect, the subsequently formed via will not meet expectations. Therefore, before etching, the substrate modification region measurement apparatus and method of the present disclosure will measure the modification region of the substrate. If there is a modification region that has not been modified successfully and/or has the defect, additional modification processing or other processing can be performed to ensure that the subsequently formed via meets expectations, thereby further improving the yield rate of the substrate with vias.

According to one objective of the present disclosure, the present disclosure provides a substrate modification region measurement apparatus comprising a first image capturing device, a second image capturing device and a microcontroller unit. The first image capturing device is disposed on a first surface of a substrate. The first image capturing device orthogonally faces the first surface of the substrate, and is configured to shoot the substrate to obtain a first image. The second image capturing device is disposed under a first surface of a substrate. The second image capturing device orthogonally faces the second surface of the substrate, and is configured to shoot the substrate to obtain a second image, wherein the first surface of the substrate is opposite to the second surface of the substrate. The microcontroller unit is signally connected to the first image capturing device and the second image capturing device, and is configured to obtain modification region measuring information of at least one modification region according to the first image and the second image

According to one objective of the present disclosure, the present disclosure provides a substrate modification region measurement method, and the method comprises steps as follows: providing a first collimated light beam which orthogonally illuminates a second surface of the substrate and propagates toward a first image capturing device, and making the first image capturing device shoot the substrate to obtain a first image, wherein the second surface of the substrate is opposite to a first surface of the substrate, and the first image capturing device is disposed on the first surface of the substrate; providing a second collimated light beam which orthogonally illuminates a first surface of the substrate and propagates toward a second image capturing device, and making the second image capturing device shoot the substrate to obtain a second image, wherein the second image capturing device is disposed under the second surface of the substrate; providing a third collimated light beam which obliquely illuminates the second surface or the first surface of the substrate and propagates toward a third image capturing device, and making the third image capturing device shoot the substrate to obtain a third image, wherein the third image capturing device is disposed on the first surface of the substrate and at a side of the first image capturing device, and obliquely faces the first surface of the substrate, or alternatively, the third image capturing device is disposed under the second surface of the substrate and at a side of the second image capturing device, and obliquely faces the second surface of the substrate; and using a microcontroller unit to obtain modification region measuring information of at least one modification region according to the first image, the second image and the third image.

According to one objective of the present disclosure, the present disclosure provides a substrate modification region measurement method, and the method comprises steps as follows: providing a first collimated light beam which orthogonally illuminates a second surface of the substrate and propagates toward a first image capturing device, and making the first image capturing device shoot the substrate to obtain a first image, wherein the second surface of the substrate is opposite to a first surface of the substrate, the first image capturing device is disposed on the first surface of the substrate, a first polarization lens is disposed between the first surface of the substrate and the first image capturing device, a second polarization lens is disposed between the second surface of the substrate and a first collimated light source which provides the first collimated light beam, and a polarization direction of the first polarization lens is orthogonal to a polarization direction of the second polarization lens; providing a second collimated light beam which orthogonally illuminates the first surface of the substrate and propagates toward a second image capturing device, and making the second image capturing device shoot the substrate to obtain a second image, wherein the second image capturing device is disposed under the second surface of the substrate, the second polarization lens is disposed between the second surface of the substrate and the second image capturing device, and the first polarization lens is disposed between the first surface of the substrate and a second collimated light source which provides the second collimated light beam; and using a microcontroller unit to obtain modification region measuring information of at least one modification region according to the first image and the second image.

To sum up, the present disclosure provides a substrate modification region measurement apparatus and method, each of which is able to measure the modification region of the substrate, thereby improving the yield rate of the substrate with vias.

### BRIEF DESCRIPTION OF DRAWINGS

FIG. 1 is a schematic diagram of a substrate modification region measurement apparatus according to a first embodiment of the present disclosure.

FIG. 2 is a schematic diagram of a substrate modification region measurement apparatus according to a second embodiment of the present disclosure.

FIG. 3 is a schematic diagram of a substrate modification region measurement apparatus according to a third embodiment of the present disclosure.

FIG. 4 is a flow chart of a substrate modification region measurement apparatus according to an embodiment of the present disclosure.

FIG. 5 is a schematic diagram of a first image obtained by the substrate modification region measurement apparatus according to the first embodiment of the present disclosure.

FIG. 6 is a schematic diagram of a second image obtained by the substrate modification region measurement apparatus according to the first embodiment of the present disclosure.

FIG. 7 is a schematic diagram of a third image obtained by the substrate modification region measurement apparatus according to the first embodiment of the present disclosure.

FIG. 8 is a schematic diagram of a substrate modification region measurement apparatus according to a fourth embodiment of the present disclosure.

FIG. 9 is a schematic diagram of a first image obtained by the substrate modification region measurement apparatus according to the fourth embodiment of the present disclosure.

FIG. 10 is a schematic diagram of a second image obtained by the substrate modification region measurement apparatus according to the fourth embodiment of the present disclosure.

FIG. 11 is a schematic diagram of a substrate modification region measurement apparatus according to a fifth embodiment of the present disclosure.

FIG. 12 is a schematic diagram of a third image obtained by the substrate modification region measurement apparatus according to the fifth embodiment of the present disclosure.

### DETAILS OF EXEMPLARY EMBODIMENTS

In order to help the examiner understand the technical features, content, advantages and effect of the present disclosure the present disclosure is described in detail below with the accompanying drawings in the form of embodiments. The drawings are only for illustration and auxiliary description purposes, and they may not represent the actual proportions and precise configurations of the present disclosure when practicing implementation. Therefore, the proportions and configuration relationships of the accompanying drawings should not be limited to the actual implementation and claim scope of the present disclosure.

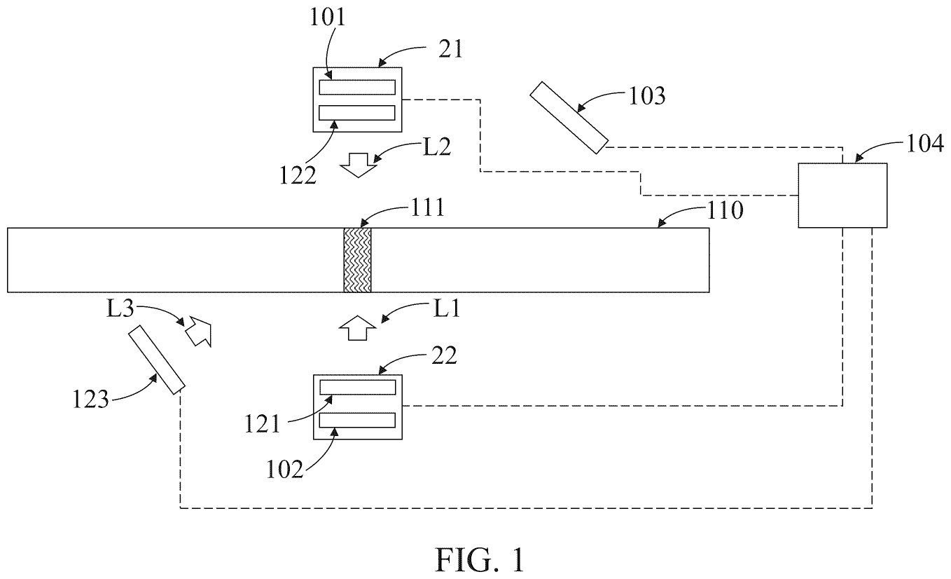

Refer to FIG. 1, and FIG. 1 is a schematic diagram of a substrate modification region measurement apparatus according to a first embodiment of the present disclosure. The substrate modification region measurement apparatus is used to measure modification regions 110 of the substrate 110, so as to obtain modification region measuring information of the modification regions 111. For example, the substrate 110 can be a glass substrate, and the modification region 111 can be a laser modification region, which is formed by illumination of a laser beam on the glass substrate, and the present disclosure is not limited to the types of the substrate 110 and the modification regions 111.

The substrate modification region measurement apparatus comprises a first image capturing device 101, a second image capturing device 102, a third image capturing device 103 and a microcontroller unit 104. The first image capturing device 101 is disposed on a first surface of the substrate 110 (for example, disposed on the top surface of the substrate 110), and orthogonally faces the first surface of the substrate 110 (i.e., an extending direction of the center optical axis of the first image capturing device 101 is perpendicular to the first surface of the substrate 110). The first image capturing device 101 shoots (i.e., takes a photograph on) the substrate 110 to obtain a first image. The second image capturing device 102 is disposed under a second surface of the substrate 110 (for example, disposed under the bottom surface of the substrate 110), and orthogonally faces the second surface of the substrate 110 (i.e., an extending direction of the center optical axis of the second image capturing device 102 is perpendicular to the second surface of the substrate 110). The second image capturing device 102 shoots (i.e., takes a photograph on) the substrate 110 to obtain a second image. The first surface of the substrate 110 is opposite the second surface of the substrate 110.

The third image capturing device 103 is disposed on the first surface of the substrate 110 and at a side of the first image capturing device 101 (for example, third image capturing device 103 is disposed at the right side of the first image capturing device 101, but in another embodiment, it can be disposed at the left side of the first image capturing device 101. The third image capturing device 103 obliquely faces the first surface of the substrate 110 (i.e., an extending direction of the center optical axis of third image capturing device 103 and the first surface of the substrate 110 have a tilting angle therebetween). The third image capturing device 103 shoots (i.e., takes a photograph on) the substrate 110 to obtain a third image. The microcontroller unit 104 is signally connected to the first image capturing device 101, the second image capturing device 102 and the third image capturing device 103 via a wire or wireless manner, and obtains modification region measuring information of at least one modification region 111 of the substrate 110 according to the first image, the second image and the third image.

Specifically, the modification region measuring information of the modification region 111 comprises a first position of the modification region 111 at the first surface of the substrate 110, a second position of the modification region 111 at the second surface of the substrate 110 and a modification information of the modification region, wherein the modification information of the modification region indicates whether the modification region has been modified successfully and/or has a defect (for example, impurity or dirty, and the present disclosure is not limited thereto). The modification region measuring information of the modification region 111 is not limited to the above contents, and the modification region measuring information of the modification region 111 can comprises other contents, for example, the size information (length of major axis diameter and length of minor axis diameter) of the modification region 111 at the first surface and second surface of substrate 110 and the true roundness of the modification region 111 at the first surface and second surface of substrate 110.

The modification region measuring information can be used to evaluate whether the substrate 110 can be etched or not, such that it avoids the low yield rate of subsequently formed substrate with vias (for example, but not limited to the TGV substrate). If the modification region measuring information indicates that the substrate 110 can be performed with modification processing again or other processing to make the modification region 111 meet the acceptable requirements, the substrate 110 will be performed with modification processing again or other processing, such that the yield rate of subsequently formed substrate with vias will be increases.

In the embodiment, the substrate modification region measurement apparatus further comprises a first collimated light source 121, a second collimated light source 122 and a third collimated light source 123. The first collimated light source 121 is signally connected to the microcontroller unit 104 via the wire or wireless manner, and disposed under the second surface of the substrate 110. The first collimated light source 121 orthogonally faces the second surface the substrate 110 (i.e., an extending direction of the center optical axis of the first collimated light source 121 is perpendicular to the second surface of the substrate 110), and provides a first collimated light beam L1 which orthogonally illuminates the second surface the substrate 110 and propagates toward the first image capturing device 101. The second collimated light source 122 is signally connected to the microcontroller unit 104 via the wire or wireless manner, and disposed on the first surface of the substrate 110. The second collimated light source 122 orthogonally faces the first surface the substrate 110 (i.e., an extending direction of the center optical axis of the second collimated light source 122 is perpendicular to the first surface of the substrate 110), and provides a second collimated light beam L2 which orthogonally illuminates the first surface the substrate 110 and propagates toward the second image capturing device 102. The third collimated light source 123 is signally connected to the microcontroller unit 104 via the wire or wireless manner, and disposed under the second surface of the substrate 110. The third collimated light source 123 obliquely faces the first surface the substrate 110 (i.e., an extending direction of the center optical axis of the third collimated light source 123 and the second surface of the substrate 110 have a tilting angle therebetween), and provides a third collimated light beam L3 which orthogonally illuminates the second surface the substrate 110 and propagates toward the third image capturing device 103.

Optionally, the first image capturing device 101 and the second collimated light source 122 can be integrated into a first telecentric imaging module 21, and the second image capturing device 102 and the first collimated light source 121 can be integrated into a second telecentric imaging module 22, and the present disclosure is not limited thereto. In addition, a first wavelength range of the first collimated light beam L1 can be designed to be equal to or different from a second wavelength range of the second collimated light beam L2, and a second wavelength range of the second collimated light beam L2 can be designed to be equal to or different from a third wavelength range of the third collimated light beam L3. For example, color of one the first collimated light beam L1, the second collimated light beam L2 and the third collimated light beam L3 can be white, red, green or blue. Further, one of the first image capturing device 101, the second image capturing device 102 and the third image capturing device 103 can be a color camera or a black-white camera, preferably, a color depth of field camera or a black-white depth of field camera. Moreover, in other embodiment, the first collimated light beam L1, the second collimated light beam L2 and the third collimated light beam L3 can be replaced by non-collimated light beams, and that is, the first collimated light source 121, the second collimated light source 122 and the third collimated light source 123 can be replaced by non-collimated light sources.

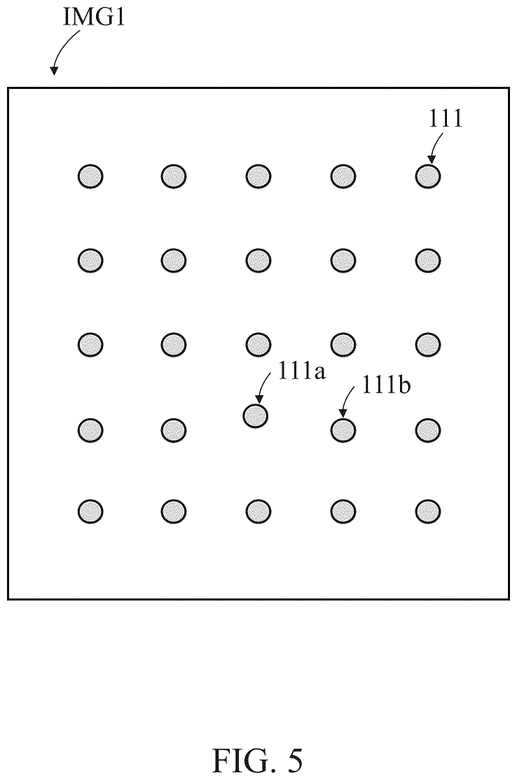

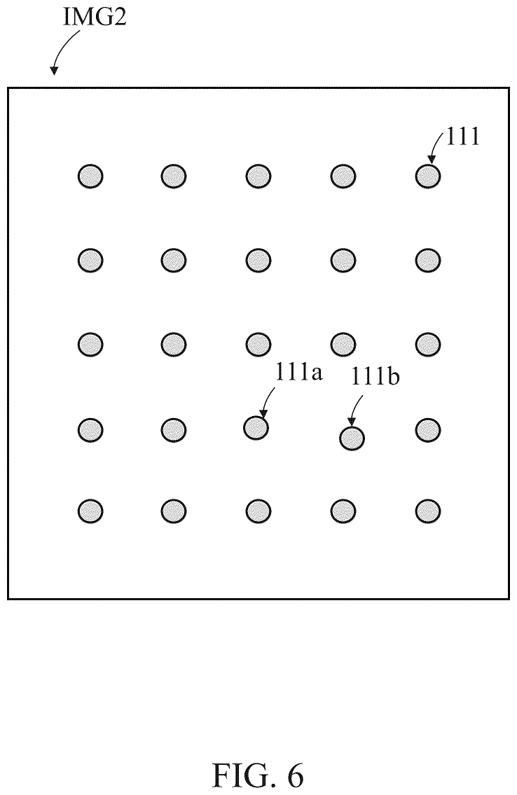

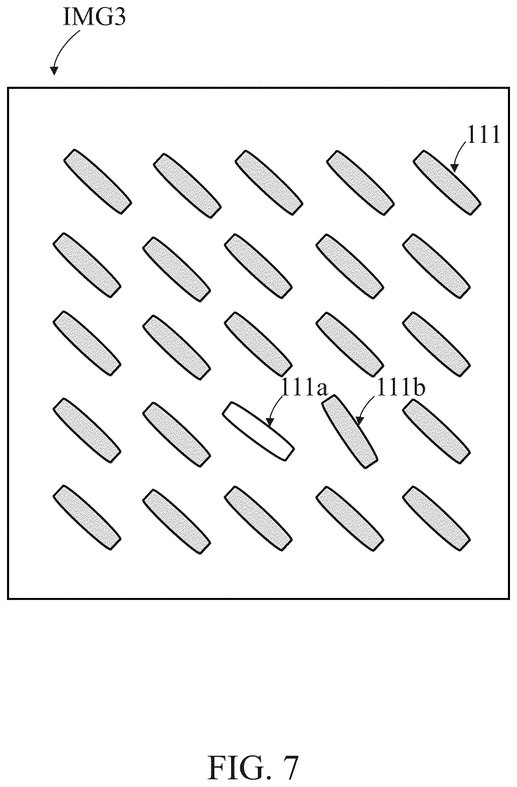

Refer to FIG. 1 and FIG. 5 through FIG. 7, FIG. 5 is a schematic diagram of a first image obtained by the substrate modification region measurement apparatus according to the first embodiment of the present disclosure, FIG. 6 is a schematic diagram of a second image obtained by the substrate modification region measurement apparatus according to the first embodiment of the present disclosure, and FIG. 7 is a schematic diagram of a third image obtained by the substrate modification region measurement apparatus according to the first embodiment of the present disclosure. As shown in FIG. 5, the first image IMG1 represents the distribution of the modification regions 111, 111a, 111b at the first surface of the substrate 110, and the microcontroller unit 104 can obtain the first positions of the modification regions 111, 111a, 111b at the first surface of the substrate 110 according to the first image IMG1. As shown in FIG. 6, the second image IMG2 represents the distribution of the modification regions 111, 111a, 111b at the second surface of the substrate 110, and the microcontroller unit 104 can obtain the second positions of the modification regions 111, 111a, 111b at the second surface of the substrate 110 according to the second image IMG2.

As shown in FIG. 7, the third image IMG3 represents the modification levels of the modification regions 111, 111a, 111b between the first surface and the second surface of the substrate 110. Further, after being modified, the reflection coefficients and refraction coefficients of the modification regions 111, 111a, 111b are changed. Compared to the non-modified regions, the light beam scatters in the modification regions 111, 111a, 111b, and thus the modification regions 111, 111a, 111b in the third image IMG3 have intensities less than those of the non-modified regions, and by using an artificial intelligence algorithm or other algorithm, the modification levels of the modification regions 111, 111a, 111b between the first surface the second surface of the substrate 110 can be evaluated. In short, the microcontroller unit 104 can obtain the modification levels of the modification regions 111, 111a, 111b between the first surface the second surface of the substrate 110 according to the third image IMG3, the first positions of the modification regions 111, 111a, 111b at the first surface of the substrate 110 and the second positions of the modification regions 111, 111a, 111b at the second surface of the substrate 110.

For example, in the embodiment, the modification region measuring information represents that the first positions of the modification regions 111a, 111b at the first surface of the substrate 110 are deviated to the second positions of the modification regions 111a, 111b at the second surface of the substrate 110, and the substrate 110 cannot be performed modification processing again or other processing to meet the requirements (for example, the deviation requirement). Thus, the substrate 110 will be regarded as the defective product. If the substrate 110 can be performed modification processing again or other processing to meet the requirements, the substrate 110 will be performed modification processing again or other processing.

In the embodiment, when the modification region measuring information represents the modification level of the modification region 111a is not enough, it means the modification region 111a has not been modified successfully. If the substrate 110 can be performed modification processing again or other processing to meet the requirements (for example, the modification level requirement), the substrate 110 will be performed modification processing again or other processing to meet the requirements (i.e., increase the modification level of the modification region 111a to make the modification region 111a be modified successfully). Therefore, the yield rate of the substrate with vias will be increased, wherein the substrate with vias is formed by etching the substrate 110.

By the way, in the above embodiment of the substrate modification region measurement apparatus, though the substrate modification region measurement apparatus comprises the third image capturing device 103 and the third collimated light source 123, the present disclosure is not limited thereto. In one embodiment, the third image capturing device 103 and the third collimated light source 123 can removed from the substrate modification region measurement apparatus, and that is, the substrate modification region measurement apparatus can be implemented without comprising the third image capturing device 103 and the third collimated light source 123, and the microcontroller unit 104 can obtain the modification region measuring information of the at least one modification region 111 of the substrate 110 according to the first image and the second image. For example, based on the sizes of the modification regions 111 of the first image IMG1 and the second image IMG2, the microcontroller unit 104 can judge whether the modification region 111 has been successfully modified and/or has a defect.

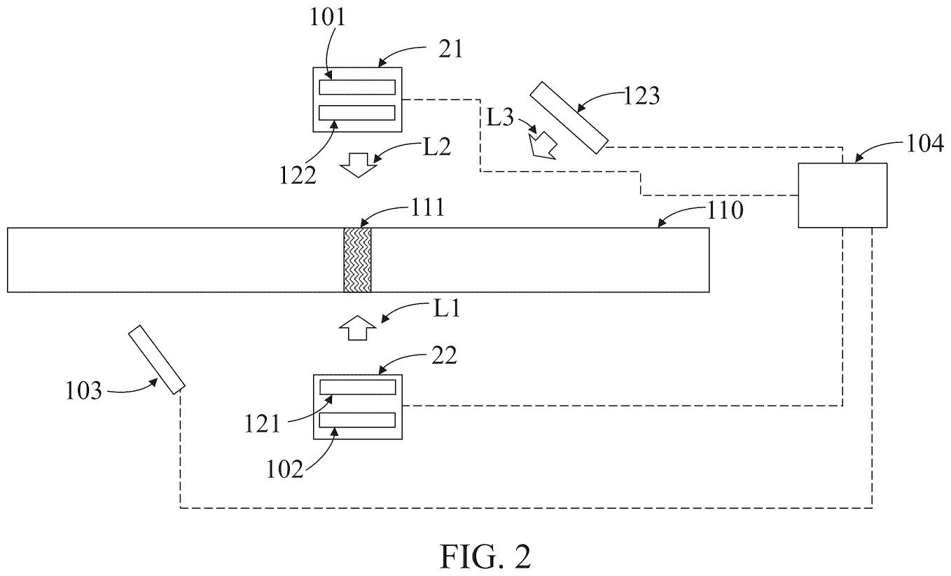

Refer to FIG. 2, and FIG. 2 is a schematic diagram of a substrate modification region measurement apparatus according to a second embodiment of the present disclosure. Being different from the embodiment of FIG. 1, in the embodiment, the third image capturing device 103 is disposed under the second surface of the substrate 110, and at a side of the second image capturing device 102, for example, at the left side of the second image capturing device 102, and in another embodiment, at the right side of the second image capturing device 102. In the embodiment, the third image capturing device 103 obliquely faces the second surface of the substrate 110, the third collimated light source 123 is disposed on the first surface of the substrate 110, and obliquely faces the first surface of the substrate 110.

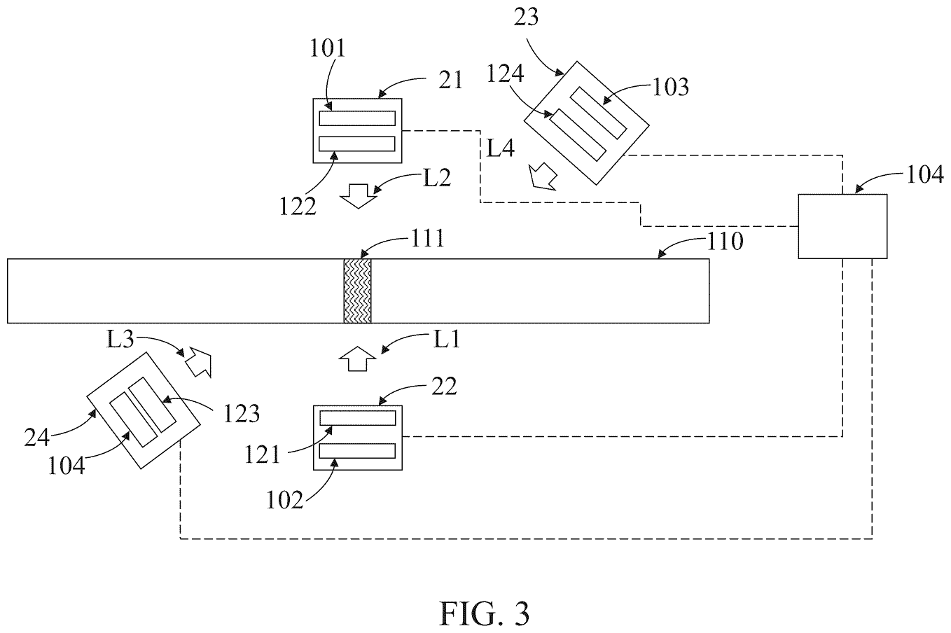

Refer to FIG. 3, and FIG. 3 is a schematic diagram of a substrate modification region measurement apparatus according to a third embodiment of the present disclosure. Being different from the embodiment of FIG. 1, in the embodiment, the substrate modification region measurement apparatus further comprises a fourth image capturing device 105 and a fourth collimated light source 124. The fourth image capturing device 105 is signally connected to the microcontroller unit 104 via the wire or wireless manner, and disposed under the second surface of the substrate 110 and at a side of the second image capturing device 102. The fourth image capturing device 105 obliquely faces the second surface of the substrate 110, and is configured to shoot the second surface of the substrate 110 to obtain a fourth image. The fourth collimated light source 124 is signally connected to the microcontroller unit 104 via the wire or wireless manner, and disposed on the first surface of the substrate 110 and at a side of the first image capturing device 101. The fourth collimated light source 124 obliquely faces the first surface of the substrate 110, and is configured to provide a fourth collimated light beam LA which obliquely illuminates the first surface of the substrate 110 and propagates toward the fourth image capturing device 105.

In the embodiment, the microcontroller unit 104 obtains the modification region measuring information of the at least one modification region 111 of the substrate according to the first image, the second image, the third image and the fourth image. The fourth image is the mirror of the image of the third image, and by using the fourth image, the accuracy of the modification region measuring information can be increased. In addition, the fourth collimated light source 124 and the third image capturing device 103 can be integrated into the third telecentric imaging module 23, and the third collimated light source 123 and the fourth image capturing device 105 can be integrated into the fourth telecentric imaging module 24, and the present disclosure is not limited thereto.

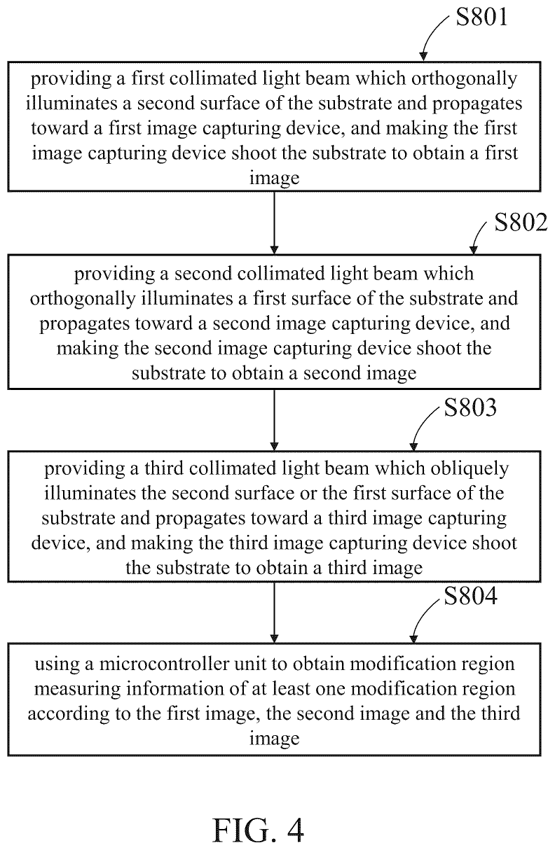

Refer to FIG. 1 and FIG. 4, or refer to FIG. 2 and FIG. 4, and FIG. 4 is a flow chart of a substrate modification region measurement apparatus according to an embodiment of the present disclosure. At a step S801, the first collimated light source 121 is used to provide the first collimated light beam L1 which orthogonally illuminates the second surface of the substrate 110 and propagates toward the first image capturing device 101, and first image capturing device 101 is used to shoot the substrate 110 to obtain the first image, wherein the second surface of the substrate 110 is opposite to the first surface of the substrate 110, and the first image capturing device 101 is disposed on the first surface of the substrate 110. Next, at a step S802, the second collimated light source 122 is used to provide the second collimated light beam L2 which orthogonally illuminates the first surface of the substrate 110 and propagates toward the second image capturing device 102, and the second image capturing device 102 is used to shoot the substrate 110 to obtain the second image, wherein the second image capturing device 102 is disposed under the second surface of the substrate 110.

Next, at a step S803, the third collimated light source 123 is used to provide the third collimated light beam L3 which obliquely illuminates the second surface of the substrate 110 (the embodiment of FIG. 1) or the first surface of the substrate 110 (the embodiment of FIG. 2), and propagates toward the third image capturing device 103, and the third image capturing device 103 is used to shoot the substrate 110 to obtain the third image, wherein the third image capturing device 103 is disposed on the first surface of the substrate 110 and at the side of the first image capturing device 101, and obliquely faces the first surface of the substrate 110 (the embodiment of FIG. 1), or alternatively, the third image capturing device 103 is disposed under the second surface of the substrate 110 and at the side of the second image capturing device 102, and obliquely faces the second surface of the substrate 110 (the embodiment of FIG. 2). Then, at a step S804, the microcontroller unit 104 is used to obtain the modification region measuring information of the at least one modification region 111 of the substrate 110 according to the first image, the second image and the third image.

Additionally, as the above mentioned description of the substrate modification region measurement apparatus, the third image capturing device 103 and the third collimated light source 123 may not be used, and that is, in another embodiment, the substrate modification region measurement method may not comprises the step S803, and at the step S804, the microcontroller unit 104 is used to obtain the modification region measuring information of the at least one modification region 111 of the substrate 110 according to the first image and the second image.

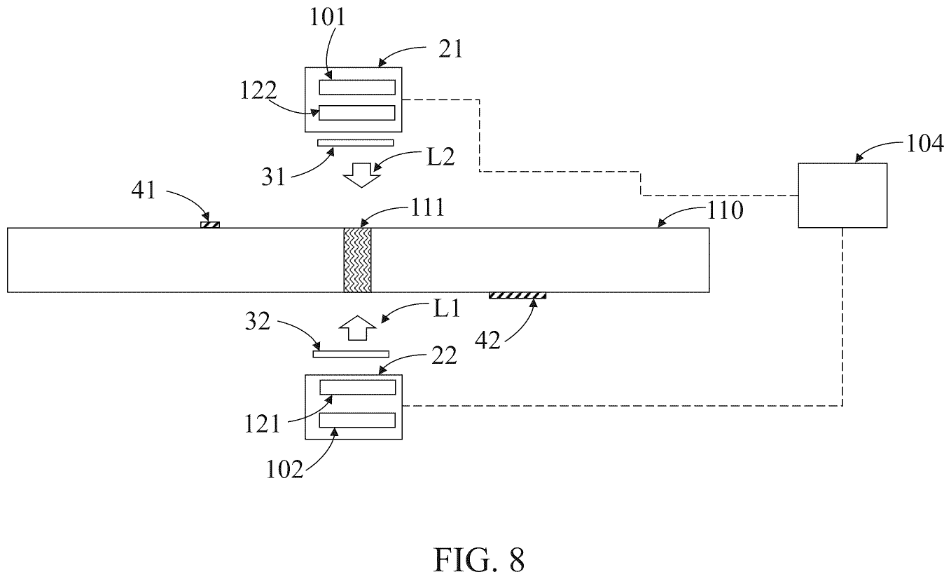

Refer to FIG. 8, and FIG. 8 is a schematic diagram of a substrate modification region measurement apparatus according to a fourth embodiment of the present disclosure. Being different from the embodiment of FIG. 1, the substrate modification region measurement apparatus of FIG. 8 does not comprise the third image capturing device 103 and the third collimated light source 123, but further comprises polarization lenses 31, 32. The polarization lens 31 is disposed between the first image capturing device 101 and the first surface of the substrate 110, and between the second collimated light source 122 and the first surface of the substrate 110. The polarization lens 32 is disposed between the second image capturing device 102 and the second surface of the substrate 110, and between the first collimated light source 121 and the second surface of the substrate 110. The polarization lenses 31, 32 are used to perform polarization filtering, such that merely the light the beams of the specific polarization can pass the corresponding one of the polarization lenses 31, 32. The polarization direction of the polarization lens 31 is orthogonal to the polarization direction of the polarization lens 32.

In the embodiment, the polarization directions of the polarization lenses 31, 32 are respectively a horizontal polarization direction and a vertical polarization direction, and the polarization directions of the first collimated light beam L1 and the second collimated light beam L2 are respectively the vertical polarization direction and the horizontal polarization direction. Since the modification region 111 is modified, the modification region 111 can change the polarization direction of the receiving light beam. By arranging the polarization lens 31, the first image capturing device 101 forms the image merely according to the receiving light beam with the horizontal polarization direction. By arranging the polarization lens 32, the second image capturing device 102 forms the image merely according to the receiving light beam with the vertical polarization direction. Generally, if the region the of substrate 110 is modified, the crystal lattice arrangement of the region will change, and thus the modification region 111 will change the polarization direction of the receiving light beam. After the first collimated light beam L1 passes the modification region 111, the polarization direction of the first collimated light beam L1 will change to a tilting polarization direction from the vertical polarization direction. The horizontal polarization direction component of the first collimated light beam L1 which passes the modification region 111 will form an image in the first image capturing device 101. After the second collimated light beam L2 passes the modification region 111, the polarization direction of the second collimated light beam L2 will change to a tilting polarization direction from the horizontal polarization direction. The vertical polarization direction component of the second collimated light beam L2 which passes the modification region 111 will form an image in the second image capturing device 102.

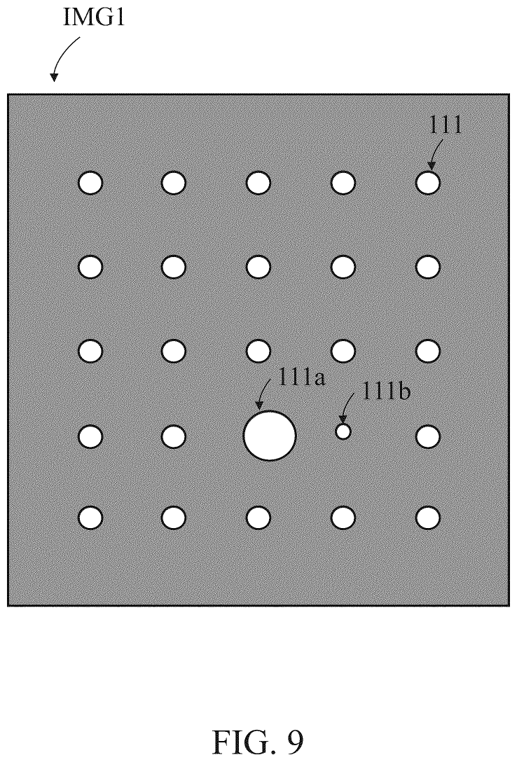

Refer to FIG. 8 and FIG. 9, and FIG. 9 is a schematic diagram of a first image obtained by the substrate modification region measurement apparatus according to the fourth embodiment of the present disclosure. In the first image IMG1 of FIG. 9, according to the above description, in addition to the modification region 111, the first collimated light beam L1 which passes the substrate 110 cannot form the image in the first image capturing device 101, thus the part outside the modification region 111 is black, and the first collimated light beam L1 which passes the modification region 111 of the substrate 110 can form the image in the first image capturing device 101 since its polarization direction is changed. Moreover, the more the modification level of the modification region 111 is, the larger the spot size of the modification region 111 imaged in the first image IMG1 is. For example, in the first image IMG1 of FIG. 9, the modification level of the modification region 111a is larger than that of other modification region 111, and the modification level of the modification region 111b is less than that of other modification region 111. Further, the spot sizes of the modification region 111a, 111b, 111 can be used to evaluate the stress condition of the substrate 110. The spot size of the modification region 111 is the proportionally enlarged size of the modification region 111 (for example, the proportion ratio is larger than or equal to 10, and it depends on the modification level), thus the first image capturing device 101 can be an image capturing device with a lower resolution, and the first collimated light beam L1 can be replaced by an non-collimated light beam.

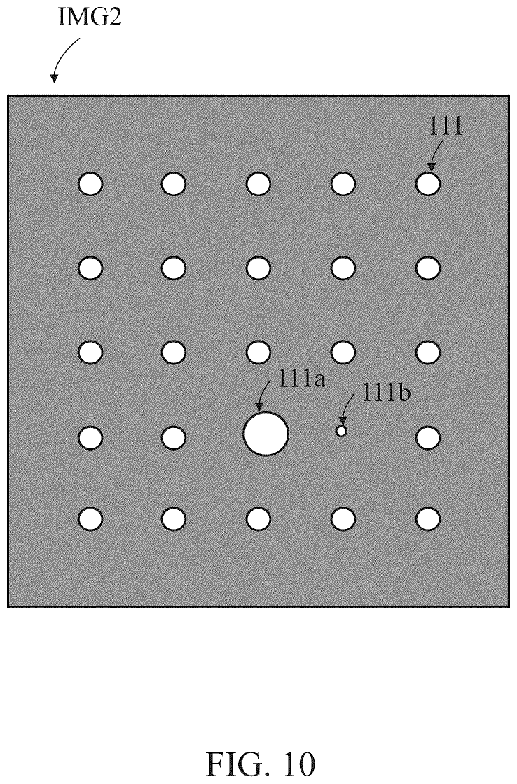

Refer to FIG. 8 and FIG. 10, and FIG. 10 is a schematic diagram of a second image obtained by the substrate modification region measurement apparatus according to the fourth embodiment of the present disclosure. In the second image IMG2 of FIG. 10, according to the above description, in addition to the modification region 111, the second collimated light beam L2 which passes the substrate 110 cannot form the image in the second image capturing device 102, thus the part outside the modification region 111 is black, and the second collimated light beam L2 which passes the modification region 111 of the substrate 110 can form the image in the second image capturing device 102 since its polarization direction is changed. Moreover, the more the modification level of the modification region 111 is, the larger the spot size of the modification region 111 imaged in the second image IMG2 is. For example, in the second image IMG2 of FIG. 10, the modification level of the modification region 111a is larger than that of other modification region 111, and the modification level of the modification region 111b is less than that of other modification region 111. Further, the spot sizes of the modification region 111a, 111b, 111 can be used to evaluate the stress condition of the substrate 110. The spot size of the modification region 111 is the proportionally enlarged size of the modification region 111 (for example, the proportion ratio is larger than or equal to 10, and it depends on the modification level), thus the second image capturing device 101 can be an image capturing device with a lower resolution, and the second collimated light beam L2 can be replaced by an non-collimated light beam.

Refer to FIG. 8 through FIG. 10. When the substrate 110 has the defects 41, 42 (for example, other particle), in the embodiments of FIG. 1 through FIG. 3, the microcontroller unit 104 must execute other algorithm to judge the defects 41, 42 and remove the defects 41, 42 in the image, to obtain the more accurate modification region measuring information of the modification region 111 of the substrate 110. However, by using the manner of FIG. 8 (the arrangement of the polarization lenses 31, 32), according to the explanation of FIG. 9 and FIG. 10, it can be known that the defects 41, 42 cannot change the polarization direction of the light beam, and the defects 41, 42 cannot be imaged in the first image IMG1 and the second image IMG2, therefore being black in the first image IMG1 and the second image IMG2. Compared to the embodiments of FIG. 1 through FIG. 3, the manner of FIG. 8 can make the microcontroller unit 104 not execute the judgement algorithm for the defects 41, 42, such that the computation time and power can be saved.

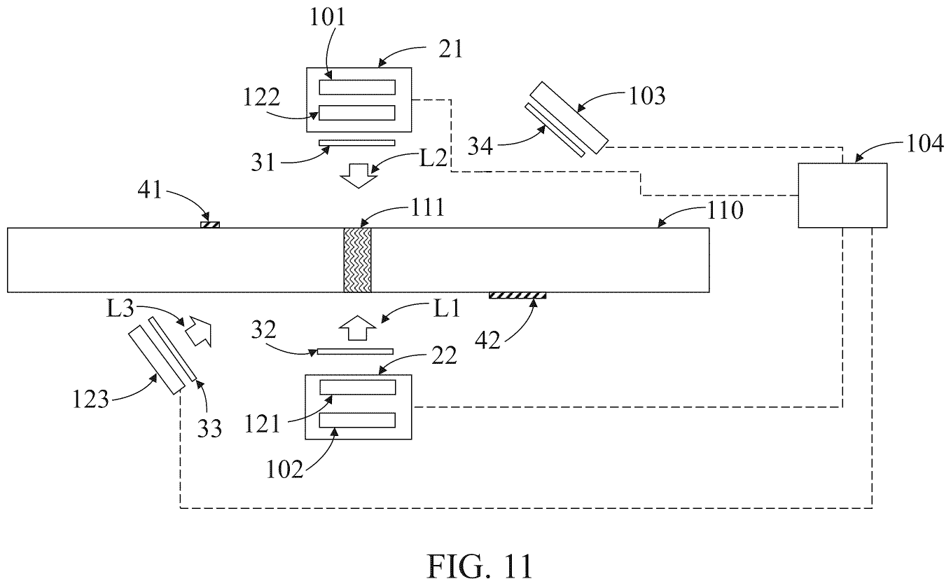

Next, refer to FIG. 11, and FIG. 11 is a schematic diagram of a substrate modification region measurement apparatus according to a fifth embodiment of the present disclosure. Being different from the embodiment of FIG. 1, the substrate modification region measurement apparatus further comprises polarization lenses 31, 32, 33, 34. The polarization direction of the polarization lens 31 is orthogonal to the polarization direction of the polarization lens 32, the polarization direction of the polarization lens 33 is orthogonal to the polarization direction of the polarization lens 34, the polarization direction of the polarization lens 31 is orthogonal to the polarization direction of the polarization lens 33, and the polarization direction of the polarization lens 32 is orthogonal to the polarization direction of the polarization lens 34. The first image and the second image obtained by the substrate modification region measurement apparatus of FIG. 11 are respectively the same as those obtained by the substrate modification region measurement apparatus of FIG. 8, and thus the repeated description is omitted.

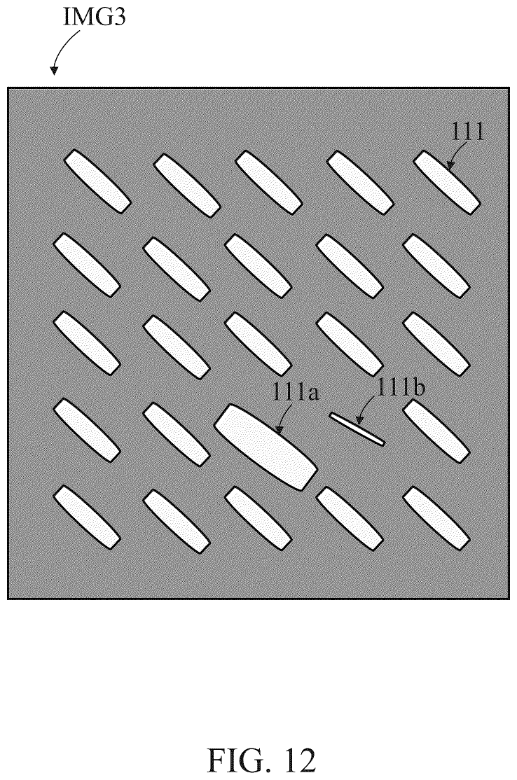

Refer to FIG. 11 and FIG. 12, and FIG. 12 is a schematic diagram of a third image obtained by the substrate modification region measurement apparatus according to the fifth embodiment of the present disclosure. In the third image IMG3 of FIG. 12, according to the above description, in addition to the modification region 111, the third collimated light beam L3 which passes the substrate 110 cannot form the image in the third image capturing device 103, thus the part outside the modification region 111 is black, and the third collimated light beam L3 which passes the modification region 111 of the substrate 110 can form the image in the third image capturing device 103 since its polarization direction is changed. Moreover, the more the modification level of the modification region 111 is, the larger the spot size of the modification region 111 imaged in the third image IMG3 is. For example, in the first image IMG3 of FIG. 12, the modification level of the modification region 111a is larger than that of other modification region 111, and the modification level of the modification region 111b is less than that of other modification region 111. Further, the spot sizes of the modification region 111a, 111b, 111 can be used to evaluate the stress condition of the substrate 110. The spot size of the modification region 111 is the proportionally enlarged size of the modification region 111 (for example, the proportion ratio is larger than or equal to 10, and it depends on the modification level), thus the third image capturing device 103 can be an image capturing device with a lower resolution, and the third collimated light beam L3 can be replaced by an non-collimated light beam.

Still back to FIG. 4, according to the above description, in some embodiment, the first collimated light beam at the step S801 is the collimated light beam which passes a first polarization lens, and the first image capturing device is disposed with a second polarization lens in its front; the second collimated light beam at the step S802 is the collimated light beam which passes the second polarization lens, and the second image capturing device is disposed with the first polarization lens in its front; and the third collimated light beam at the step S803 is the collimated light beam which passes a third polarization lens, and the third image capturing device is disposed with a fourth polarization lens in its front, wherein the polarization direction of the first polarization lens is orthogonal to the polarization direction of the second polarization lens, the polarization direction of the third polarization lens is orthogonal to the polarization direction of the fourth polarization lens, the polarization direction of the third polarization lens is equal to the polarization direction of the second polarization lens when the third collimated light beam is designed to obliquely illuminates the first surface of the substrate, and the polarization direction of the third polarization lens is equal to the polarization direction of the first polarization lens when the third collimated light beam is designed to obliquely illuminates the second surface of the substrate. Moreover, in some embodiment, the step S803 can be removed as mentioned above.

To sum up, the present disclosure provides a substrate modification region measurement apparatus and method, each of which is able to measure the modification region of the substrate. Whether the modification region has been modified successfully and/or has a defect can be judged, and if the substrate can be performed with modification processing again or other processing to meet the requirements, the substrate will be performed with modification processing again or other processing. Accordingly, it ensures that before etching the substrate, the modification region has been modified successfully and does not have the defect, thereby improving the yield rate of the subsequently formed substrate with vias.

The foregoing description summarizes the features of the embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

1. A substrate modification region measurement apparatus, comprising:
a first image capturing device, disposed on a first surface of a substrate and orthogonally facing the first surface of the substrate, configured to shoot the substrate to obtain a first image;
a second image capturing device, disposed under a first surface of a substrate and orthogonally facing the second surface of the substrate, configured to shoot the substrate to obtain a second image, wherein the first surface of the substrate is opposite to the second surface of the substrate;
a microcontroller unit, signally connected to the first image capturing device and the second image capturing device, configured to obtain modification region measuring information of at least one modification region according to the first image and the second image;
a first light source, signally connected to the microcontroller unit, disposed under the second surface of the substrate and orthogonally facing the second surface of the substrate, configured to provide a first light beam which illuminates the substrate and propagates toward the first image capturing device; and
a second light source, signally connected to the microcontroller unit, disposed on the first surface of the substrate and orthogonally facing the first surface of the substrate, configured to provide a second light beam which illuminates the substrate and propagates toward the second image capturing device.

2. The substrate modification region measurement apparatus of claim 1, further comprising:
a third image capturing device, signally connected to the microcontroller unit, disposed on the first surface of the substrate and at a side of the first image capturing device, and obliquely facing the first surface of the substrate, or alternatively, disposed under the second surface of the substrate and at a side of the second image capturing device, and obliquely facing the second surface of the substrate;
a third light source, signally connected to the microcontroller unit, disposed under the second surface of the substrate or on the first surface of the substrate and obliquely facing the second surface of the substrate or the first surface of the substrate, configured to provide a third light beam which illuminates the substrate and propagates toward the third image capturing device, wherein the third image capturing device is configured to shoot the substrate to obtain a third image;
wherein the microcontroller unit is configured to obtain the modification region measuring information of the modification region according to the first image, the second image and the third image.

3. The substrate modification region measurement apparatus of claim 2, wherein the modification region measuring information of the modification region comprises a first position of the modification region at the first surface of the substrate, a second position of the modification region at the second surface of the substrate and a modification information of the modification region, wherein the modification information of the modification region indicates whether the modification region has been modified successfully and/or has a defect.

4. The substrate modification region measurement apparatus of claim 3, wherein the microcontroller unit obtains the first position of the modification region at the first surface of the substrate according to the first image, the microcontroller unit obtains the second position of the modification region at the second surface of the substrate according to the second image, and the microcontroller unit obtains the modification information of the modification region according to the third image, the first position of the modification region at the first surface of the substrate and the second position of the modification region at the second surface of the substrate.

5. The substrate modification region measurement apparatus of claim 1, further comprising:
two first polarization lenses, wherein two polarization directions of the two first polarization lenses are orthogonal to each other, one of the two first polarization lenses is disposed between the first image capturing device and the first surface of the substrate, and between the second light source and the first surface of the substrate, and other one of the two first polarization lenses is disposed between the second image capturing device and the second surface of the substrate, and between the first light source and the second surface of the substrate.

6. The substrate modification region measurement apparatus of claim 2, further comprising:
two first polarization lenses, wherein two polarization directions of the two first polarization lenses are orthogonal to each other, one of the two first polarization lenses is disposed between the first image capturing device and the first surface of the substrate, and between the second light source and the first surface of the substrate, and other one of the two first polarization lenses is disposed between the second image capturing device and the second surface of the substrate, and between the first light source and the second surface of the substrate;
two second polarization lenses, wherein two polarization directions of the two second polarization lenses are orthogonal to each other, one of the two second polarization lenses is disposed between the third image capturing device and the first surface or second surface of the substrate, and other one of the two second polarization lenses is disposed between the third light source and the second surface or first surface of the substrate.

7. The substrate modification region measurement apparatus of claim 2, wherein a first wavelength range of the first light beam is different from or equal to a second wavelength range of the second light beam, and the second wavelength range of the second light beam is different from or equal to a third wavelength range of the third light beam.

8. The substrate modification region measurement apparatus of claim 1, wherein the modification region of the substrate is a laser modification region, the substrate is a glass substrate, and the substrate is illuminated by a laser light beam to form the laser modification region.

9. The substrate modification region measurement apparatus of claim 2, wherein one of the first image capturing device, the second image capturing device and the third image capturing device is a color depth of field camera or a black-white depth of field camera.

10. The substrate modification region measurement apparatus of claim 7, wherein color of one of the first light beam, the second light beam and the third light beam is white, red, green or blue.

11. The substrate modification region measurement apparatus of claim 1, wherein the first light source is a first collimated light source, the second light source is a second collimated light source, the first image capturing device and the second collimated light source are integrated into a first telecentric imaging module, and the second image capturing device and the first collimated light source are integrated into a second telecentric imaging module.

12. The substrate modification region measurement apparatus of claim 2, wherein the third image capturing device is disposed on the first surface of the substrate, the third light source is disposed under the second surface of the substrate, and the substrate modification region measurement apparatus further comprises:
a fourth image capturing device, signally connected to the microcontroller unit, disposed under the second surface of the substrate, disposed at the side of the second image capturing device, and obliquely facing the second surface of the substrate, configured to shoot the substrate to obtain a fourth image; and
a fourth light source, signally connected to the microcontroller unit, disposed on the first surface of the substrate, and obliquely facing the first surface of the substrate, configured to provide a fourth light beam which illuminates the substrate and propagates toward the fourth image capturing device;
wherein the microcontroller unit obtains the modification region measuring information of the modification region of the substrate according to the first image, the second image, the third image and the fourth image.

13. The substrate modification region measurement apparatus of claim 12, wherein the third light source is a third collimated light source, the fourth light source is a fourth collimated light source, the fourth collimated light source and the third image capturing device are integrated into a third telecentric imaging module, and the third collimated light source and the fourth image capturing device are integrated into a fourth telecentric imaging module.

14. A substrate modification region measurement method, comprising:
providing a first collimated light beam which orthogonally illuminates a second surface of the substrate and propagates toward a first image capturing device, and making the first image capturing device shoot the substrate to obtain a first image, wherein the second surface of the substrate is opposite to a first surface of the substrate, and the first image capturing device is disposed on the first surface of the substrate;
providing a second collimated light beam which orthogonally illuminates a first surface of the substrate and propagates toward a second image capturing device, and making the second image capturing device shoot the substrate to obtain a second image, wherein the second image capturing device is disposed under the second surface of the substrate;
providing a third collimated light beam which obliquely illuminates the second surface or the first surface of the substrate and propagates toward a third image capturing device, and making the third image capturing device shoot the substrate to obtain a third image, wherein the third image capturing device is disposed on the first surface of the substrate and at a side of the first image capturing device, and obliquely faces the first surface of the substrate, or alternatively, the third image capturing device is disposed under the second surface of the substrate and at a side of the second image capturing device, and obliquely faces the second surface of the substrate; and
using a microcontroller unit to obtain modification region measuring information of at least one modification region according to the first image, the second image and the third image.

15. A substrate modification region measurement method, comprising:
providing a first collimated light beam which orthogonally illuminates a second surface of the substrate and propagates toward a first image capturing device, and making the first image capturing device shoot the substrate to obtain a first image, wherein the second surface of the substrate is opposite to a first surface of the substrate, the first image capturing device is disposed on the first surface of the substrate, a first polarization lens is disposed between the first surface of the substrate and the first image capturing device, a second polarization lens is disposed between the second surface of the substrate and a first collimated light source which provides the first collimated light beam, and a polarization direction of the first polarization lens is orthogonal to a polarization direction of the second polarization lens;
providing a second collimated light beam which orthogonally illuminates the first surface of the substrate and propagates toward a second image capturing device, and making the second image capturing device shoot the substrate to obtain a second image, wherein the second image capturing device is disposed under the second surface of the substrate, the second polarization lens is disposed between the second surface of the substrate and the second image capturing device, and the first polarization lens is disposed between the first surface of the substrate and a second collimated light source which provides the second collimated light beam; and
using a microcontroller unit to obtain modification region measuring information of at least one modification region according to the first image and the second image.

16. The substrate modification region measurement method of claim 15, wherein a first wavelength range of the first collimated light beam is different from or equal to a second wavelength range of the second collimated light beam.

17. The substrate modification region measurement method of claim 15, wherein the modification information of the modification region indicates whether the modification region has been modified successfully and/or has a defect.

18. The substrate modification region measurement method of claim 15, wherein the modification region of the substrate is a laser modification region, the substrate is a glass substrate, and the substrate is illuminated by a laser light beam to form the laser modification region.

19. The substrate modification region measurement method of claim 15, wherein the first image capturing device and the second collimated light source are integrated into a first telecentric imaging module, and the second image capturing device and the first collimated light source are integrated into a second telecentric imaging module.

20. The substrate modification region measurement method of claim 15, wherein color of one of the first collimated light beam and the second collimated light beam is white, red, green or blue, and one of the first image capturing device and the second image capturing device is a color depth of field camera or a black-white depth of field camera.
